(19) United States
(12) Patent Application Publication
(10) Pub. No.: US 2006/0033675 A1
(43) Pub. Date: Feb. 16, 2006

(54) Two-in-one ceiling suction type display device for displaying computer screen and video screen

(76) Inventor: Chung-Wu Chia, Jhonghe City (TW)

Correspondence Address: Rightech Corporation, P. O. Box No. 6-57, Junghe, Taipei, 235, TW

(21) Appl. No.: 10/918,436

(22) Filed: Aug. 16, 2004

(51) Int. Cl. G09G 5/00

(52) U.S. Cl. 345/1.2

(57) ABSTRACT

The present invention provides a two-in-one ceiling suction type display device for displaying computer screen and video screen having structural characteristics such that a video signal circuit board is connected to a laptop computer device by means of a connector, and a screen signal from the laptop computer is converted into a signal by means of the video signal circuit board, whereupon the signal is transmitted to a display circuit of a screen by means of a connecting cable, and the signal is thus displayed on the screen A1. Furthermore, a video terminal is configured on the display circuit, therewith enabling connecting to other video display devices.

### BACKGROUND OF THE INVENTION

(a) Field of the Invention

The present invention provides a two-in-one ceiling suction type display device for displaying computer screen and video screen having structural characteristics such that a video signal circuit board is connected to a laptop computer device by means of a connector, and a screen signal from the laptop computer is converted into a signal by means of the video signal circuit board, whereupon the signal is transmitted to a display circuit of a screen by means of a connecting cable, and the signal is thus displayed on the screen A1. Furthermore, a video terminal is configured on the display circuit, therewith enabling connecting to other video display devices.

(b) Description of the Prior Art

A conventional ceiling suction type screen is limited to function in conjunction with a video device within a vehicle, for instance, a vehicle stereo system device, and so on. However, if vehicle passengers are proceeding with a conference, a majority of the passengers will use a laptop computer or other handheld digital devices to record information or use such as a presentation tool. However, while the vehicle is moving, freely changing places becomes difficult for the passengers, as well as being hazardous, moreover, when the laptop computer is continually transmitting to other passengers, an accident can easily occur whereby the laptop computer is inadvertently dropped causing damage to data within the laptop computer.

Hence, the inventor of the present invention expects to resolve and surmount existent technical difficulties in eliminating the aforementioned shortcomings.

### SUMMARY OF THE INVENTION

The present invention provides a two-in-one ceiling suction type display device for displaying computer screen and video screen.

In order to better explicitly disclose advancement and practicability of the present invention, a comparative analysis with conventional art is described hereinafter:

Shortcomings of conventional art

1. Inability to function in conjunction with other video signal devices.

2. Inability to function in conjunction with the laptop computer.

Advantages of the present invention

1. Ability to function in conjunction with the laptop computer and other digital devices.

2. Benefits vehicle passengers in allowing viewing of contents as displayed on the laptop computer or other digital devices.

3. Provides advancement and practicability.

4. Enhances commercial competitiveness.

In conclusion, the present invention in surmounting structural shortcomings of prior art has assuredly achieved effectiveness of anticipated advancement, and moreover, is easily understood by persons unfamiliar with related art. Furthermore, contents of the present invention have not been publicly disclosed prior to this application, and advancement and practicability of the present invention clearly comply with essential elements as required for application of a new patent model. Accordingly, a patent application is proposed herein.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view according top the present invention.

FIG. 2 shows a rear view according top the present invention.

FIG. 3 shows a schematic view of an embodiment according to the present invention.

### DETAILED DESCRIPTION OF THE PREFERRED EMBODIMENTS

The embodiment of the present invention provides a two-in-one ceiling suction type display device for displaying computer screen and video screen.

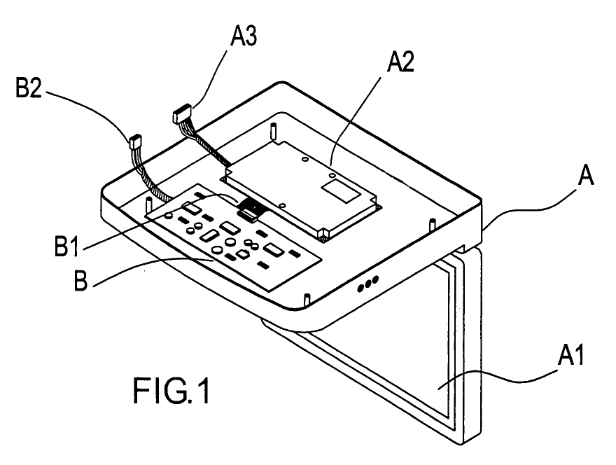

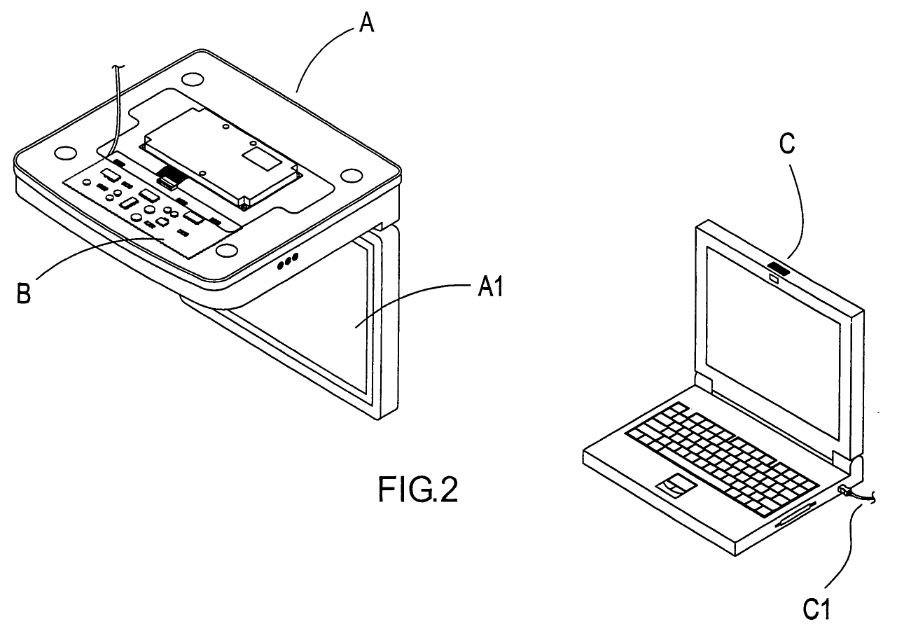

Referring to FIGS. 1 and 2, which show the ceiling suction type display device structured to comprise a ceiling suction type screen A and a video signal circuit board B. Structural characteristics of the present invention are such that the video signal circuit board B is connected to a laptop computer device by means of a connector B2, and a screen signal from the laptop computer is converted into a signal by means of the video signal circuit board B, whereupon the signal is transmitted to a display circuit A2 of a screen A1 by means of a connecting cable B1, and the signal is thus displayed on the screen A1. A video terminal A3 is configured on the display circuit A2, therewith enabling connecting to other video display devices such as a vehicle stereo system, and so on.

Furthermore, the connector B2 of the video signal circuit board B is configured as a VGA connector (Video Graphics Array Video connector) or other related digital signal transmission connectors.

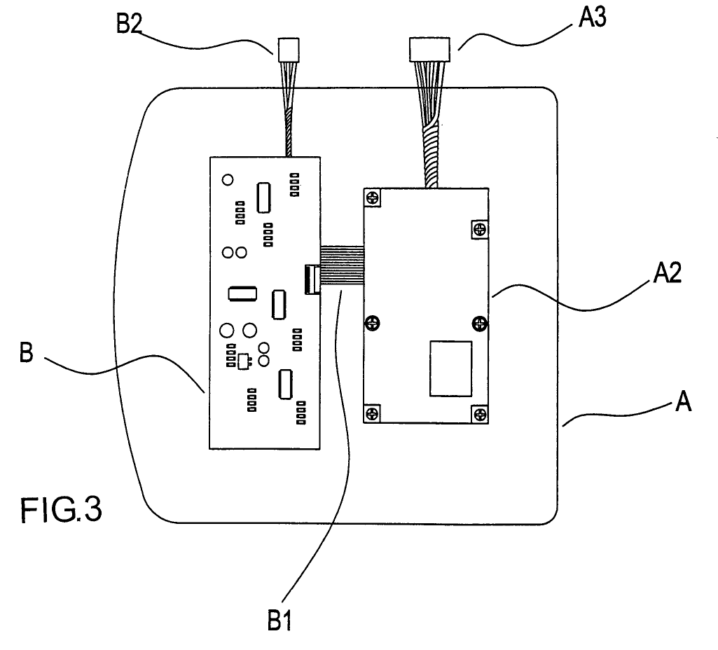

Referring to FIG. 3, which shows a laptop computer C, which links up with a video signal circuit board B by means of an output terminal C1, thereby enabling contents being displayed on a screen of the laptop computer C to be transmitted to the ceiling suction type screen A, and thus allowing other passengers within a vehicle to view the same contents as displayed on the laptop computer on the screen A1.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A two-in-one ceiling suction type display device for displaying computer screen and video screen comprising a ceiling suction type screen and a video signal circuit board, and characterized in that the video signal circuit board is connected to a laptop computer device by means of a connector, and a screen signal from the laptop computer is converted into a signal by means of the video signal circuit board, whereupon the signal is transmitted to a display circuit of a screen by means of a connecting cable, and the signal is thus displayed on the screen; furthermore, a video terminal is configured on the display circuit, therewith enabling connecting to other video display devices.

2. The two-in-one ceiling suction type display device for displaying computer screen and video screen according to claim 1, wherein the connector of the video signal circuit board is configured as a VGA connector (Video Graphics Array Video connector) or other related digital signal transmission connectors.
